(19) United States
(12) Patent Application Publication
(10) Pub. No.: US 2025/0373330 A1
(43) Pub. Date: Dec. 4, 2025

(54) OPTICAL TRANSMISSION CHARACTERISTICS ESTIMATION APPARATUS, OPTICAL TRANSMISSION CHARACTERISTICS ESTIMATION METHOD, AND PROGRAM

(71) Applicant: NIPPON TELEGRAPH AND TELEPHONE CORPORATION, Tokyo (JP)

(72) Inventors: Takeo SASAI, Musashino-shi (JP); Etsushi YAMAZAKI, Musashino-shi (JP); Masanori NAKAMURA, Musashino-shi (JP)

(73) Assignee: NIPPON TELEGRAPH AND TELEPHONE CORPORATION, Tokyo (JP)

(21) Appl. No.: 18/874,017

(22) PCT Filed: Jun. 15, 2022
(86) PCT No.: PCT/JP2022/023960

§ 371 Date: Dec. 11, 2024

(51) Int. Cl. H04B 10/075; H04B 10/61

(52) U.S. Cl. CPC H04B 10/075; H04B 10/61

(57) ABSTRACT

Optical transmission property estimation device comprising:
a transmission waveform restoration unit configured to restore a transmission signal from a reception signal obtained by receiving an optical signal by a coherent detection system; and
an estimation unit configured to estimate an optical power distribution in a transmission line by estimating a nonlinear coefficient in a propagation equation of a light wave by a linear least square method based on the restored transmission signal and the reception signal.

### TECHNICAL FIELD

The present invention relates to an optical transmission property estimation device, an optical transmission property estimation method, and a program.

### BACKGROUND ART

When optical transmission systems operate, basic properties of optical fibers included in optical transmission lines greatly affect transmission performance. Here, the basic properties of the optical transmission lines include optical power, distribution of fiber loss and dispersion, and positions of loss anomalies. For example, when the optical power is too large, an influence of a nonlinear optical effect in an optical fiber becomes significant, making the signal-to-noise ratio (hereinafter referred to as “SNR”) low. When the loss is too large, attenuation of the optical power accordingly increases. Therefore, the SNR decreases.

Therefore, it is important to know the properties of the optical transmission lines for the operation, maintenance and monitoring of the optical transmission system. An optical transmission line includes various devices, for example, an optical amplifier and an optical filter, in addition to an optical fiber. It is also important to know properties of these devices for the operation, maintenance, and monitoring of the optical transmission system.

Properties of devices such as optical fibers, optical amplifiers, and optical filters can be generally measured by analogue measurement instruments such as an optical time domain reflectometer (OTDR) and optical spectrum analyzer. However, in measurement in which analogue measurement instruments requires to be placed at each optical node or each optical fiber. Thus, equipment costs and operation costs tend to increase.

In order to solve this problem, in recent years, digital longitudinal monitoring (DLM) that is a technique for detecting properties of various devices in an optical transmission system through digital signal processing on the receiver side of the optical transmission system has been proposed in place of measurement by an analogue measurement instrument (for example, see NPL 1 and NPL 2). The DLM is based on a digital coherent optical transmission system and monitors optical power or the like which is a property of the optical transmission line by performing digital signal processing on a reception signal obtained by performing coherent detection of an optical signal transmitted by the optical transmission line.

In NPL 1, a method using correlation is used, and it is referred to here as a correlation method. In NPL 2, a method called a channel reconstruction method utilizing a gradient method is used.

### CITATION LIST

### Non Patent Literature

[NPL 1] T. Tanimura, et al., “Fiber-Longitudinal Anomaly Position Identification Over Multi-Span Transmission Link Out of Receiver-end Signals”, JLT, 38(9), 2020.
[NPL 2] T. Sasai, et al., “Digital longitudinal monitoring of Optical Fiber Communication Link”, JLT, 40(8), 2022.

### SUMMARY OF INVENTION

### Technical Problem

However, in a correlation method described in NPL 1, the sensitivity is limited in principle, and thus only relative optical power can be estimated. Accordingly, in the correlation method described in NPL 1, sufficient accuracy of optical power estimation cannot be obtained. In a channel reconstruction method described in NPL 2, although it achieves greater sensitivity than a correlation method, the channel reconstruction method is a nonlinear least square method using a gradient descent method, a hyper parameter (for example, a learning rate, the number of learning times, initial values, and the like) must be appropriately set. Further, the channel reconstruction method described in NPL 2 increases the calculation load. As described above, the conventional method has a problem that the optical transmission properties cannot be estimated with high accuracy while reducing a calculation load with a small number of parameter settings.

In view of the foregoing circumstances, an object of the present invention is to provide a technique capable of easily estimating optical transmission properties with high accuracy while reducing a calculation load with a small number of parameter settings.

### Solution to Problem

According to an aspect of the present invention, an optical transmission property estimation device includes: a transmission waveform restoration unit configured to restore a transmission signal from a reception signal obtained by receiving an optical signal by a coherent detection system; and an estimation unit configured to estimate an optical power distribution in a transmission line by estimating a nonlinear coefficient in a propagation equation of a light wave by a linear least square method based on the restored transmission signal and the reception signal.

According to another aspect of the present invention, an optical transmission property estimation method includes: restoring a transmission signal from a reception signal obtained by receiving an optical signal by a coherent detection system; and estimating an optical power distribution in a transmission line by estimating a nonlinear coefficient in a propagation equation of a light wave by a linear least square method based on the restored transmission signal and the reception signal.

According to still another aspect of the present invention, a program causes a computer to execute: restoring a transmission signal from a reception signal obtained by receiving an optical signal by a coherent detection system; and estimating an optical power distribution in a transmission line by estimating a nonlinear coefficient in a propagation equation of a light wave by a linear least square method based on the restored transmission signal and the reception signal.

### Advantageous Effects of Invention

According to the present invention, it is possible to easily estimate optical transmission properties with high accuracy while reducing a calculation load with a small number of parameter settings.

### BRIEF DESCRIPTION OF DRAWINGS

FIG. 1 A diagram (part 1) illustrating an overview of the present invention.

FIG. 2 A diagram (part 2) illustrating the overview of the present invention.

FIG. 3 A diagram illustrating a configuration example of an optical reception device according to an embodiment.

FIG. 4 An exemplary flowchart illustrating a processing flow of the optical reception device according to the embodiment.

FIG. 5 A diagram illustrating a simulation result for comparing a method of the related art (correlation method) with a scheme of the present invention.

### DESCRIPTION OF EMBODIMENTS

Hereinafter, an embodiment of the present invention will be described with reference to the drawings.

First, an overview of the present invention will be described. In order to obtain an optical power distribution P(z) in an optical transmission line (optical fiber) of an optical transmission system including an optical transmission device, an optical reception device, and an optical transmission line connecting the optical transmission device to the optical reception device, γ′(z) of the nonlinear Schroedinger equation represented by the following Formula (1), which is an equation describing propagation of light waves in the optical transmission line may be obtained. Here, γ′(z) in Formula (1) is represented by the following Formula (2).

$$\begin{matrix}[ Math . 1 ] & \\ \frac{\partial A}{{\partial }_{Z}} = ( \frac{j}{2} {β}_{2} \frac{{\partial }^{2}}{\partial {t}^{2}} ) A - j {γ}^{′} ( z ) {‖ A ‖}^{2} A & Formula ( 1 )\end{matrix}$$

$$\begin{matrix}[ Math . 2 ] & \\ {γ}^{′} ( z ) = γ P ( z ) & Formula ( 2 )\end{matrix}$$

In Formula (1), z represents a distance (km) on an optical transmission line, t represents a time (s), A represents an optical electric field in which ∫|A(z,t)|²dt is normalized to 1, and β₂ represents a group velocity dispersion coefficient (ps²/km). In Formula (2), γ represents a nonlinear constant (1/W/kin), and P(z) represents power (W) in the optical transmission line.

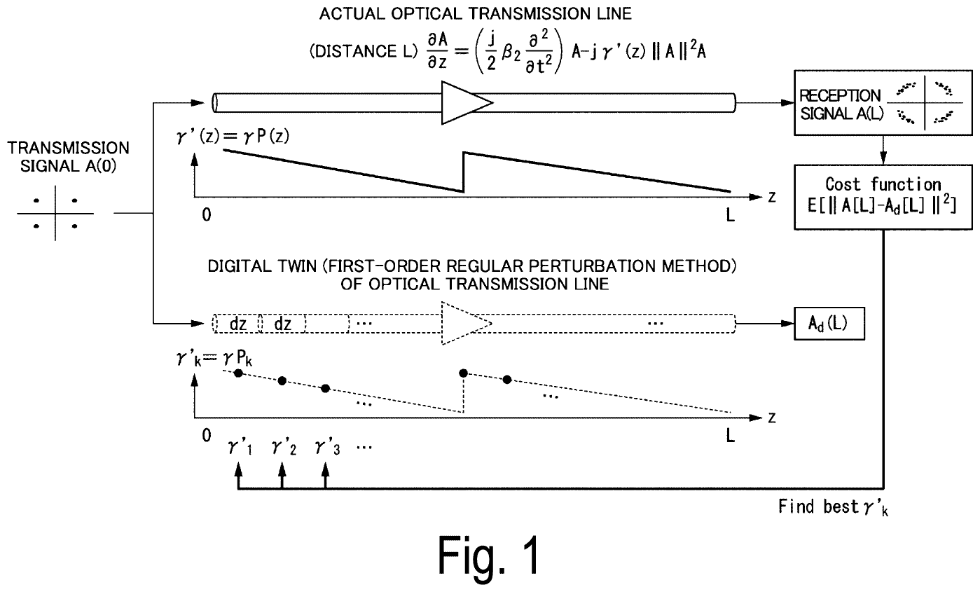

Here, as a method of estimating γ′(z)=γP(z) in an actual optical transmission line, a method of preparing a virtual transmission line (digital twin of the actual optical transmission line, simulation) by a first-order regular perturbation method is exemplified as illustrated in FIG. 1. FIG. 1 is a diagram (part 1) illustrating an overview of the present invention. An output (virtual reception signal) from a virtual transmission line prepared by the first-order regular perturbation method is denoted as A_{d}(L). A parameter γₖ′ in the virtual transmission line in which the reception signal A_{d}(L) from the virtual transmission line is closest to the actual reception signal A(L) (the square error is minimized) may be obtained. When this problem is formulated, this problem can be expressed as in the following Formula (3).

$$\begin{matrix}[ Math . 3 ] & \\ \hat{{γ}_{k}^{′}} = {arg min}_{{γ}_{k}^{′}} E [ {‖ A [ L ] - {A}_{d} [ L ] ‖}^{2} ] & Formula ( 3 )\end{matrix}$$

The electric field waveform A(L) at the position z=L after transmission of the optical transmission line can be expressed as in the following Formula (4) using the first-order regular perturbation method.

$$\begin{matrix}[ Math . 4 ] & \\ A ( L ) ≃ {A}_{0} ( L ) + {A}_{1} ( L ) & Formula ( 4 )\end{matrix}$$

A₀(L) and A₁(L) in Formula (4) are calculated based on the following Formulae (5) and (6), respectively.

$$\begin{matrix}[ Math . 5 ] & \\ {A}_{0} ( L ) = [ {A}_{0} ( 0 ) ] & Formula ( 5 )\end{matrix}$$

$$\begin{matrix}[ Math . 6 ] & \\ {A}_{1} ( L , t ) = - j {\int }_{0}^{L} {γ}^{′} ( z ) [ \hat{N} [ [ A ( 0 , t ) ] ] ] dz & Formula ( 6 )\end{matrix}$$

$$Also , \\ [ \cdot ] = \frac{j}{2} {β}_{2} z \frac{{\partial }^{2}}{\partial {t}^{2}} ( \cdot ) : \\ an operator representing a wavelength dispersion of distance z \\ \hat{N} [ . ] = {\vert \cdot \vert}^{2} ( \cdot ) : a nonlinear operator$$

Also,
an operator representing a chromatic dispersion of distance z
a nonlinear operator[0026]

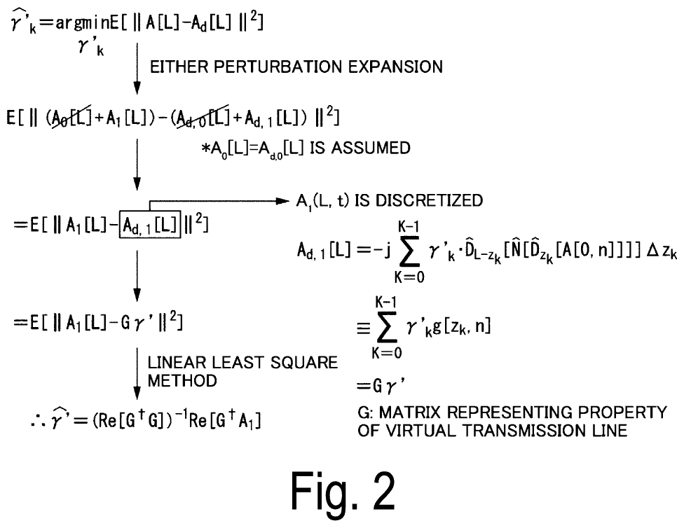

By substituting a formula of the first-order regular perturbation shown by Formula (4) into Formula (3), this problem can be reduced to a problem of the linear least square method as illustrated in FIG. 2. FIG. 2 is a diagram (part 2) illustrating the overview of the present invention.

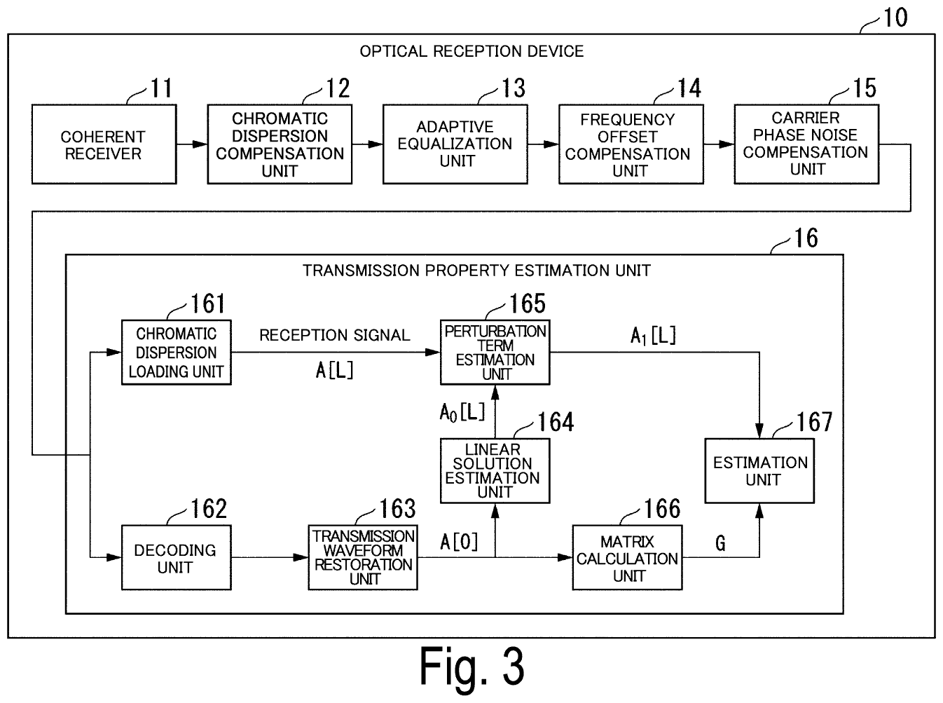

FIG. 3 is a diagram illustrating a configuration example of an optical reception device 10 according to an embodiment. The optical reception device 10 receives a transmission signal transmitted from the optical transmission device connected via the optical transmission line. The optical reception device 10 includes a coherent receiver 11, a chromatic dispersion compensation unit 12, an adaptive equalization unit 13, a frequency offset compensation unit 14, a carrier phase noise compensation unit 15, and a transmission property estimation unit 16.

The coherent receiver 11 is connected to the optical transmission line, receives an optical signal transmitted by the optical transmission line, and performs coherent detection. The coherent receiver 11 performs polarization demultiplexing to divide the received optical signal into an X-polarized wave and a Y-polarized wave. The coherent receiver 11 detects an I component and a Q component of each of the X-polarized wave and the Y-polarized wave by interfering each of the optical signals of the X-polarized wave and the Y-polarized wave subjected to the polarization separation to interfere with a laser beam emitted from a local oscillation light source provided inside. The coherent receiver 11 converts each of the optical signals of the I component and the Q component of each of the X-polarized wave and the Y-polarized wave into four series analogue electric signals, and converts the converted four series analogue signals into four series digital signals by four analogue-digital converters provided inside and outputs the series digital signals. Hereinafter, four series digital signals output from the coherent receiver 11 are referred to as reception signals.

The chromatic dispersion compensation unit 12 estimates a chromatic dispersion received in the optical fiber transmission line, compensates for the estimated chromatic dispersion for the reception signal output from the coherent receiver 11, and outputs the compensated electrical signal to the adaptive equalization unit 13.

The adaptive equalization unit 13 is a functional unit that compensates for the distortion generated in a waveform of the optical signal in the optical transmission line using the reception signal output from the chromatic dispersion compensation unit 12. That is, the adaptive equalization unit 13 is a functional unit which corrects a code error caused in the optical signal by inter-code interference (inter-symbol interference) in the optical transmission line. The adaptive equalization unit 13 performs adaptive equalization processing by a finite impulse response (FIR) filter according to a set tap coefficient.

The frequency offset compensation unit 14 performs processing for compensating for a frequency offset on the reception signal on which the adaptive equalization processing has been performed.

The carrier phase noise compensation unit 15 performs processing for compensating for a phase offset on the reception signal of which the frequency offset has been compensated for.

The transmission property estimation unit 16 estimates an optical power distribution (optical transmission property) of the optical transmission line. The transmission property estimation unit 16 includes a chromatic dispersion loading unit 161, a decoding unit 162, a transmission waveform restoration unit 163, a linear solution estimation unit 164, a perturbation term estimation unit 165, a matrix calculation unit 166, and an estimation unit 167. The transmission property estimation unit 16 is a type of optical transmission property estimation device.

The chromatic dispersion loading unit 161 estimates a chromatic dispersion received in the optical fiber transmission line and loads the estimated chromatic dispersion to the reception signal output from the carrier phase noise compensation unit 15. Accordingly, the chromatic dispersion loading unit 161 generates a signal obtained by performing polarization demultiplexing, frequency offset compensation, phase noise compensation, or the like from the reception signal received by the coherent receiver 11. chromatic dispersion addition unit 161 generates a signal obtained by removing polarization separation, frequency offset, phase noise, or the like from the reception signal obtained by receiving an optical signal by a coherent detection system. The reception signal generated by the chromatic dispersion loading unit 161 is a signal before chromatic dispersion compensation in which polarization separation, frequency offset, phase noise, or the like are removed. Hereinafter, the reception signal generated by the chromatic dispersion loading unit 161 will be described as a reception signal A[L].

The decoding unit 162 decodes the reception signal output from the carrier phase noise compensation unit 15.

The transmission waveform restoration unit 163 restores the waveform of the transmission signal transmitted by the optical transmission device based on the reception signal decoded by the decoding unit 162. The waveform of the transmission signal restored by the transmission waveform restoration unit 163 is a waveform of the transmission signal input to a virtual transmission line expressed by a digital twin (primary regular perturbation method) of the optical transmission line illustrated in FIG. 1. Hereinafter, the waveform of the transmission signal restored by the transmission waveform restoration unit 163 is described as a transmission signal A[0].

The linear solution estimation unit 164 estimates a linear solution in which only a chromatic dispersion (linear phenomenon) is applied from the transmission signal A[0] restored by the transmission waveform restoration unit 163. Hereinafter, the linear solution estimated by the linear solution estimation unit 164 is described as a linear solution A₀[L].

The perturbation term estimation unit 165 inputs the reception signal A[L] generated by the chromatic dispersion loading unit 161 and the linear solution A₀[L] estimated by the linear solution estimation unit 164. The perturbation term estimation unit 165 estimates a perturbation term A₁[L] obtained by removing the component of the linear solution A₀[L] from the input reception signal A[L]. In this way, the perturbation term estimation unit 165 estimates the perturbation term A₁[L] by subtracting the linear solution A₀[L] of the propagation equation of the light wave from the reception signal A[L].

The matrix calculation unit 166 calculates a matrix G representing a property of the virtual transmission line based on the transmission signal A[0] restored by the transmission waveform restoration unit 163.

The estimation unit 167 estimates a nonlinear coefficient γ′ of a propagation equation of the light wave based on the perturbation term A₁[L] estimated by the perturbation term estimation unit 165 and the matrix G calculated by the matrix calculation unit 166. The estimation unit 167 estimates an optical power distribution of the optical transmission line using the nonlinear coefficient γ′ in the estimated propagation equation of the light wave.

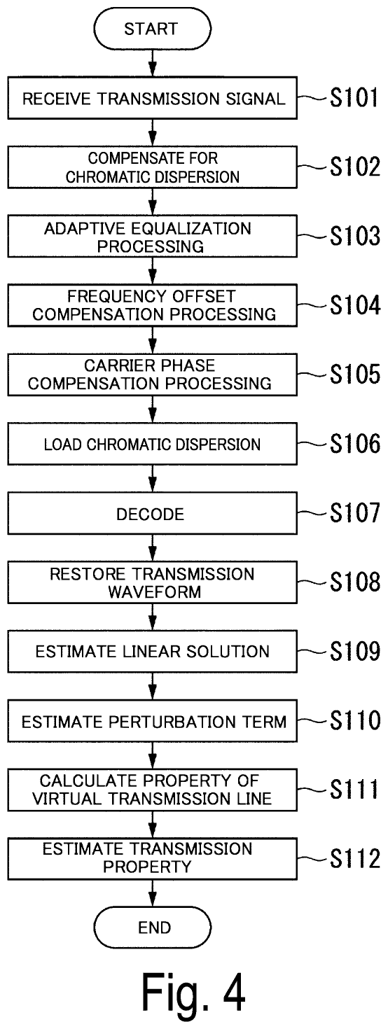

FIG. 4 is an exemplary flowchart illustrating a processing flow of the optical reception device 10 according to the embodiment.

The coherent receiver 11 of the optical reception device 10 receives the optical signal transmitted from the optical transmission device (step S101). The coherent receiver 11 outputs the reception signal to the chromatic dispersion compensation unit 12. The chromatic dispersion compensation unit 12 performs chromatic dispersion compensation on the reception signal output from the coherent receiver 11 (step S102). The chromatic dispersion compensation unit 12 outputs the reception signal subjected to the wavelength component processing to the adaptive equalization unit 13.

The adaptive equalization unit 13 performs adaptive equalization processing for compensating for distortion occurring in the waveform of the reception signal subjected to wavelength processing and output from the chromatic dispersion compensation unit 12 (step S103). The adaptive equalization unit 13 outputs the reception signal subjected to the adaptive equalization processing to the frequency offset compensation unit 14. The frequency offset compensation unit 14 performs the frequency offset compensation processing for compensating for the frequency offset on the reception signal subjected to the adaptive equalization processing output from the adaptive equalization unit 13 (step S104). The frequency offset compensation unit 14 outputs the reception signal subjected to the frequency offset compensation processing to the carrier phase noise compensation unit 15.

The carrier phase noise compensation unit 15 performs carrier phase compensation processing for compensating for phase offset on the reception signal subjected to the frequency offset compensation processing and output from the frequency offset compensation unit 14 (step S105). The carrier phase noise compensation unit 15 outputs the reception signal subjected to the carrier phase compensation processing to the chromatic dispersion loading unit 161 and the decoding unit 162.

The chromatic dispersion loading unit 161 loads a chromatic dispersion to the reception signal subjected to the carrier phase compensation processing and output from the carrier phase noise compensation unit 15 (step S106). Accordingly, the chromatic dispersion loading unit 161 generates a reception signal A[L]. The chromatic dispersion loading unit 161 outputs the generated reception signal A[L] to the perturbation term estimation unit 165. The decoding unit 162 decodes the reception signal subjected to the carrier phase compensation processing and output from the carrier phase noise compensation unit 15 (step S107). The decoding unit 162 outputs the decoded reception signal to the transmission waveform restoration unit 163.

The transmission waveform restoration unit 163 restores the waveform of the transmission signal transmitted by the optical transmission device based on the reception signal decoded by the decoding unit 162 (step S108). The transmission waveform restoration unit 163 outputs the transmission signal A[0] indicated by the restored waveform to the linear solution estimation unit 164 and the matrix calculation unit 166. The linear solution estimation unit 164 estimates a linear solution A₀[L] applied only by a chromatic dispersion based on the following Formula (7) using the transmission signal A[0] restored by the transmission waveform restoration unit 163 (step S109). The linear solution A₀[L] obtained by the linear solution estimation unit 164 is a reception waveform to which only the chromatic dispersion (linear phenomenon) is applied.

$$\begin{matrix}[ Math . 7 ] & \\ {A}_{0} [ L ] = {\hat{D}}_{L} [ A [ 0 ] ] & Formula ( 7 )\end{matrix}$$

The linear solution estimation unit 164 outputs the estimated linear solution A₀[L] to the perturbation term estimation unit 165. The perturbation term estimation unit 165 estimates a perturbation term A₁[L] based on the following Formula (8) using the reception signal A[L] output from the chromatic dispersion loading unit 161 and the linear solution A₀[L] output from the linear solution estimation unit 164 (step S110). The perturbation term estimation unit 165 performs processing for removing a component of the linear solution A₀[L] from the reception signal A[L]. This intention is to determine a minimum value of E[∥A−cA0∥²]. Here, c represents a complex number.

$$\begin{matrix}[ Math . 8 ] & \\ {A}_{1} [ L ] = A [ L ] - \frac{{A}_{0}^{†} [ L ] A [ L ]}{{‖ {A}_{0} [ L ] ‖}^{2}} {A}_{0} [ L ] & Formula ( 8 )\end{matrix}$$

The perturbation term estimation unit 165 outputs the estimated perturbation term A₁[L] to the estimation unit 167. The matrix calculation unit 166 calculates the matrix G representing the property of the virtual transmission line based on the following Formula (9) using the transmission signal A[0] restored by the transmission waveform restoration unit 163 (step S111).

$$\begin{matrix}[ Math . 9 ] & \\ G ≡ {G}_{nk} = - j {\hat{D}}_{L - {z}_{k}} [ \hat{N} [ {\hat{D}}_{{z}_{k}} [ A [ 0 , n ] ] ] ] Δ {z}_{k} & Formula ( 9 )\end{matrix}$$

The matrix calculation unit 166 outputs the calculated matrix G to the estimation unit 167.

The estimation unit 167 estimates a nonlinear coefficient γ′ of the propagation equation of the light wave based on the perturbation term A₁[L] output from the perturbation term estimation unit 165 and the matrix G output from the matrix calculation unit 166. The estimation unit 167 estimates an optical power distribution P(z) of the optical transmission line based on Formula (2) using the estimated nonlinear coefficient γ′ (step S112). That is, the estimation unit 167 estimates the optical power distribution in the transmission line by estimating the nonlinear coefficient γ′ of the propagation equation of the light wave by the linear least square method.

### (Simulation Result)

Under the following conditions, a simulation was performed to compare a method of the related art (correlation method) with a scheme of the present invention.
Modulation scheme: Probabilistically shaped 64QAM 130 GBd
Root raised cosine: roll-off 0.1
Transmission line model: Split-step Fourier method
Fiber loss: a=0.20 (dB/km)
Fiber dispersion: β₂=−21.7 (ps²/km)
Fiber nonlinear constant: g=1.30 (W⁻¹km⁻¹)
Optical amplifier noise index: NF=5.0 (dB)
Measurement granularity: 0.5 (km)
50 km×3 span

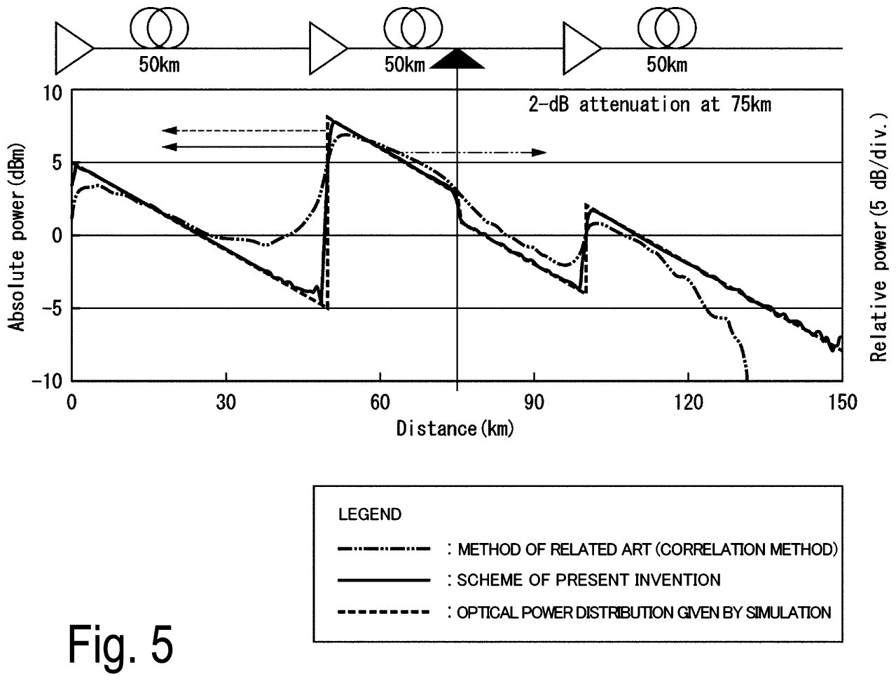

FIG. 5 is a diagram illustrating a simulation result for comparing a method of the related art (correlation method) with a scheme of the present invention. In the example illustrated in FIG. 5, the optical power is attenuated at 75 km point in order to simulate an abnormal loss in the English Translation of optical transmission line. Referring to FIG. 5, it is indicated that the scheme of the present invention is relatively consistent with a theory. In this way, the abnormal loss can be detected with a high accuracy and sensitivity by the scheme of the present invention. On the other hand, it can be understood that only unambiguous detection is made in the method of the related art.

The optical reception device 10 that has the foregoing configuration includes: a transmission waveform restoration unit configured to restore a transmission signal from a reception signal obtained by receiving an optical signal by a coherent detection system; and an estimation unit configured to estimate an optical power distribution in a transmission line by estimating a nonlinear coefficient in a propagation equation of a light wave by a linear least square method based on the restored transmission signal and the reception signal. Accordingly, it is possible to estimate the optical transmission properties with high accuracy while reducing a calculation load with a small number of parameter settings.

### Application Example of Present Invention

The present invention can be applied to estimation of various optical transmission line properties. By performing the power distribution estimation on optical signals with various wavelengths, it is possible to estimate a gain spectrum of an optical amplifier and a power spectrum at any position on an optical fiber. Further, by acquiring the optical power distribution by both the X-polarized wave and a Y-polarized wave, it is possible to estimate an amount and a position of a polarization dependent loss (PDL).

### Modification Example 1

In the above-described embodiment, propagation of a light wave in the optical transmission line may be obtained using another model instead of the propagation equation of the light wave. For example, in the above-described embodiment, a model based on the nonlinear Schroedinger equation is used, but the present invention is not limited thereto. Any model may be used as long as the model can represent propagation in an optical transmission line. For example, as a model for obtaining propagation of a light wave in an optical transmission line, a Manakov polarization mode dispersion (PMD) equation may be used.

### Modification Example 2

In the above-described embodiment, Δzₖ was set to a constant value. In order to improve a spatial resolution of a specific place, a part of Δzₖ may be set to be fine.

### Modification Example 3

In the above-described embodiment, γ′(z) is estimated to minimize a square error between a reception signal obtained by coherent detection and a virtual reception signal obtained by propagating a transmission signal along a virtual transmission line. On the contrary, γ′(z) may be estimated to minimize a square error between the transmission signal and a signal obtained by inversely propagating the reception signal obtained by coherent detection along the virtual transmission line.

### Modification Example 4

The transmission property estimation unit 16 may not be included in the optical reception device 10. In this case, the transmission property estimation unit 16 is configured as one transmission property estimation device. The transmission property estimation device receives a reception signal subjected to carrier phase compensation processing from the optical reception device 10. The transmission property estimation device outputs the received reception signal subjected to the carrier phase compensation processing to the chromatic dispersion loading unit 161 and the decoding unit 162. Subsequent processing is similar to the processing (for example, processing after step S106) in the above-described embodiment.

### Modification Example 5

As described with reference to FIG. 1, the transmission property estimation unit 16 may estimate the optical power distribution in the transmission line by obtaining the parameter γₖ′ in the virtual transmission line in which the reception signal A_{d}(L) of the virtual transmission line is closest to the actual reception signal A(L) (the square error is minimized). In such a configuration, the transmission property estimation unit 16 estimates an optical power distribution in the transmission line by estimating a nonlinear coefficient in the propagation equation of the light wave by the linear least square method using the pseudo reception signal (A_{d}(L)) obtained as a numerical solution of the propagation equation of the light wave using the transmission signal restored by the transmission waveform restoration unit 163 and the reception signal (A(L)).

Some or all of the functional units of the above-described optical reception device 10 are implemented as software by causing a processor such as a central processing unit (CPU) to execute programs stored in a storage device and a storage unit including a nonvolatile recording medium (non-transitory recording medium). The program may be recorded in a computer-readable non-transitory recording medium. Examples of the computer-readable non-transitory recording medium include a portable medium such as a flexible disc, a magneto-optical disc, a read only memory (ROM), or a compact disc read only memory (CD-ROM), and a non-transitory recording medium such as a storage device including a hard disk built in a computer system.

Some or all of the functional units of the optical reception device 10 may be implemented, for example, using hardware including electronic circuits or circuitry in which large a scale integrated (LSI) circuit, an application specific integrated circuit (ASIC), a programmable logic devices (PLD) or a field programmable gate arrays (FPGA), or the like is used.

Although the embodiment of the present invention has been described in detail with reference to the drawings, a specific configuration is not limited to this embodiment, and design within the scope of the gist of the present invention, and the like are included.

### INDUSTRIAL APPLICABILITY

The present invention can be applied to a technique for estimating a transmission property in a digital coherent optical transmission system.

### REFERENCE SIGNS LIST

10 Optical reception device
11 Coherent receiver
12 Chromatic dispersion compensation unit
13 Adaptive equalization unit
14 Frequency offset compensation unit
15 Carrier phase noise compensation unit
16 Transmission property estimation unit
161 Chromatic dispersion loading unit
162 Decoding unit
163 Transmission waveform restoration unit
164 Linear solution estimation unit
165 Perturbation term estimation unit
166 Matrix calculation unit
167 Estimation unit

1. An optical transmission property estimation device comprising:
a transmission waveform restore configured to restore a transmission signal from a reception signal obtained by receiving an optical signal by a coherent detection system; and
an estimator configured to estimate an optical power distribution in a transmission line by estimating a nonlinear coefficient in a propagation equation of a light wave by a linear least square method based on the restored transmission signal and the reception signal.

2. The optical transmission property estimation device according to claim 1, wherein the estimator uses an approximate solution using a perturbation method as a numerical solution of a propagation equation of the light wave.

3. The optical transmission property estimation device according to claim 1, further comprising:
a linear solution estimator configured to estimate a linear solution subjected to chromatic dispersion using the restored transmission signal;
a perturbation term estimator configured to estimate a perturbation term by subtracting the linear solution from a signal based on the reception signal; and
a matrix calculator configured to calculate a matrix representing a property of a virtual transmission line using the restored transmission signal,
wherein the estimator estimates the optical power distribution in the transmission line by estimating a nonlinear coefficient in the propagation equation of the light wave by a linear least square method using the perturbation term estimated by the perturbation term estimator and the matrix calculated by the matrix calculator.

4. The optical transmission property estimation device according to claim 3, further comprising a chromatic dispersion loader configured to estimate chromatic dispersion received in an optical transmission line and load the estimated chromatic dispersion to the reception signal to generate the signal.

5. The optical transmission property estimation device according to claim 1, wherein the estimator estimates an optical power distribution in a transmission line by estimating a nonlinear coefficient in a propagation equation of the light wave by a linear least square method using a pseudo reception signal obtained as a numerical solution of the propagation equation of the light wave using the restored transmission signal and the reception signal.

6. An optical transmission property estimation method comprising:
restoring a transmission signal from a reception signal obtained by receiving an optical signal by a coherent detection system; and
estimating an optical power distribution in a transmission line by estimating a nonlinear coefficient in a propagation equation of a light wave by a linear least square method based on the restored transmission signal and the reception signal.

7. A non-transitory storage medium that stores a program for making a computer perform processes, the processes comprising:
restoring a transmission signal from a reception signal obtained by receiving an optical signal by a coherent detection system; and
estimating an optical power distribution in a transmission line by estimating a nonlinear coefficient in a propagation equation of a light wave by a linear least square method based on the restored transmission signal and the reception signal.
